(19) United States
(12) Patent Application Publication
(10) Pub. No.: US 2019/0049407 A1
(43) Pub. Date: Feb. 14, 2019

(54) ELECTROPHORESIS CHIP WITH AN INTEGRATED OPTICAL SENSOR

(71) Applicant: Shenzhen Genorivision Technology Co., Ltd., Shenzhen (CN)

(72) Inventors: Rui DING, Shenzhen (CN); Peiyan CAO, Shenzhen (CN)

(21) Appl. No.: 16/160,281

(22) Filed: Oct. 15, 2018

Related U.S. Application Data
(63) Continuation of application No. PCT/CN2016/095851, filed on Aug. 18, 2016.

(51) Int. Cl. G01N 27/447

(52) U.S. Cl. CPC G01N 27/44721

(57) ABSTRACT

Disclosed herein is a method of electrophoresis, comprising: introducing an analyte into a channel; electrophoresing the analyte by establishing a first electric field between a first electrode upstream to the analyte and a second electrode downstream to the analyte; electrophoresing the analyte by establishing a second electric field between a third electrode upstream to the analyte and a fourth electrode downstream to the analyte; wherein the fourth electrode is downstream to the second electrode.

### TECHNICAL FIELD

The disclosure herein relates to devices for electrophoresis.

### BACKGROUND

Electrophoresis is a method for separation and analysis of particles (e.g., DNA, RNA and proteins and their fragments, nanoparticles, beads, etc.), based on their size and charge. Electrophoresis involves placing the particles in an electric field. The particles drift in the electric field because they are electrically charged. Lighter particles move faster and drift farther than heavier particles within a given amount of time.

Electrophoresis may use a gel as an anti-convective medium or sieving medium, through which the particles drift under the electric field. The gel may suppress the thermal convection caused by application of the electric field, and may retard the passage of particles. Examples of the gel include agarose and polyacrylamide gels. After the electrophoresis is complete, the particles in the gel can be visualized, for example, by staining them. DNA may be visualized using ethidium bromide which, when intercalated into DNA, fluoresces under ultraviolet light, while protein may be visualized using silver stain or Coomassie Brilliant Blue dye. Based on the visualization of the gel, particles in different portions of the gel may be separated by physically cutting the gel.

Capillary electrophoresis uses submillimeter diameter capillaries (e.g., microfluidic and nanofluidic channels). Capillary electrophoresis may forgo the use of a gel. The particles subject to capillary electrophoresis drift in the capillaries by electroosmotic flow, under an electric field along the capillaries. The particles separate as a result of their dissimilar electrophoretic mobility.

### SUMMARY

Disclosed herein is a device, comprising: an electrophoresis channel; a first plurality of at least three electrodes configured to establish an electric field in a part of the electrophoresis channel but not in another part, or to establish electric fields of different strengths in different parts of the electrophoresis channel; an optical detector integrated with the electrophoresis channel, configured to detect a signal of an analyte as the analyte passes across the optical detector during electrophoresis.

According to an embodiment, the device further comprises a buffer reservoir configured to receive or store a buffer solution and fluidly coupled to the electrophoresis channel.

According to an embodiment, the device further comprises a sample reservoir configured to receive or store a solution containing the analyte and fluidly coupled to the electrophoresis channel.

According to an embodiment, the device further comprises a coupling channel, wherein the sample reservoir is fluidly coupled to the electrophoresis channel through the coupling channel.

According to an embodiment, the device further comprises a waste reservoir fluidly coupled to the electrophoresis channel through the coupling channel.

According to an embodiment, the sample reservoir and the coupling channel are configured to direct the analyte into the electrophoresis channel.

According to an embodiment, the coupling channel crosses the electrophoresis channel at a crossing and wherein the sample reservoir and the coupling channel are configured to direct the analyte into the crossing.

According to an embodiment, the device further comprises a second plurality of at least three electrodes configured to direct the analyte from the sample reservoir along the coupling channel.

According to an embodiment, the first plurality of electrodes are individually controllable.

According to an embodiment, the first plurality of electrodes are exposed to an interior of the electrophoresis channel.

According to an embodiment, the optical detector is between two neighboring ones of the first plurality of electrodes, or wherein the optical detector is underneath some of the first plurality of electrodes, or wherein the optical detector is on a side of the electrophoresis channel opposite to the first plurality of electrodes.

According to an embodiment, the signal is fluorescence, transmission of light, or scattering of light.

According to an embodiment, the optical detector is configured to detect a signal from a part of the electrophoresis channel.

According to an embodiment, the optical detector is a CMOS optical detector.

According to an embodiment, the device further comprises a plurality of collection channels fluidly coupled to an outlet of the electrophoresis channel and further comprising a plurality of collection reservoirs fluidly coupled to the collection channels, wherein the collection channels and the collection reservoirs are configured to receive components of the analyte contained in electrophoresis bands in the electrophoresis channel.

According to an embodiment, the device further comprises a third plurality of electrodes configured to direct the components into the collection reservoirs.

According to an embodiment, the electrophoresis channel comprises a trench in a substrate and a cover plate closing the trench.

According to an embodiment, the substrate comprises glass, a polymer, or silicon.

According to an embodiment, the cover plate comprises a semiconductor, glass, or a printed circuit board.

According to an embodiment, the optical detector is in the cover plate.

According to an embodiment, the first plurality of electrodes are on the cover plate.

According to an embodiment, the device further comprises a controller comprising a processor, a memory and a power supply, wherein the controller is configured to receive an output from the optical detector, the output representing the signal the optical detector detects from the electrophoresis channel.

According to an embodiment, the processor is configured to execute instructions stored in the memory and to determine a quantity or identity of a component contained in an electrophoresis band in the electrophoresis channel.

According to an embodiment, the processor is configured to execute instructions stored in the memory and to determine a location of an electrophoresis band in the electrophoresis channel.

According to an embodiment, the processor is configured to determine when and which of the first and third plurality of electrodes to energize using the power supply, based on an identity or location of an electrophoresis band in the electrophoresis channel.

Disclosed herein is a method of electrophoresis, comprising: introducing an analyte into a channel; electrophoresing the analyte by establishing a first electric field between a first electrode upstream to the analyte and a second electrode downstream to the analyte; electrophoresing the analyte by establishing a second electric field between a third electrode upstream to the analyte and a fourth electrode downstream to the analyte; wherein the fourth electrode is downstream to the second electrode.

According to an embodiment, the third electrode is downstream to the first electrode.

According to an embodiment, a fluidic distance between the first and second electrodes is smaller than a fluidic distance between the third and fourth electrodes.

According to an embodiment, the channel has a cross-sectional area of less than 1 mm².

### BRIEF DESCRIPTION OF FIGURES

FIG. 1A schematically shows a top view of a device, according to an embodiment.

FIG. 1B shows that the collection channels are arranged such that they are fluidly coupled the electrophoresis channel without any branches.

FIG. 2 schematically shows an electrophoresis channel in a traditional electrophoresis apparatus, with two electrodes at the upstream and downstream ends of the electrophoresis channel.

FIG. 3A-FIG. 3C schematically show an example of the device that has 13 electrodes arranged along the length of the electrophoresis channel.

FIG. 4 schematically shows a flow chart for a method of electrophoresis.

FIG. 5 schematically shows the function of the optical detector.

FIG. 6 schematically shows that the device may have a controller.

FIG. 7A and FIG. 7B schematically show one way to use the electrodes to direct an electrophoresis band selectively to one of the arms of a branch.

FIG. 8A-FIG. 8C show examples of arrangements of the electrophoresis channel.

FIG. 9 schematically shows that some of the electrodes may not be controlled independently from one another.

### DETAILED DESCRIPTION

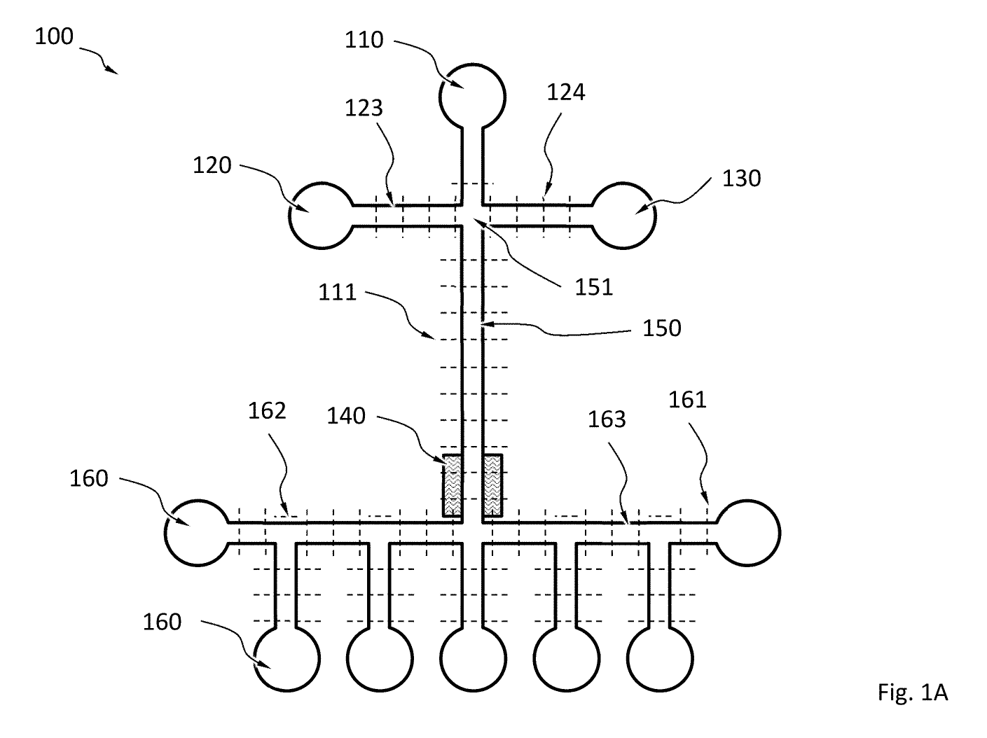

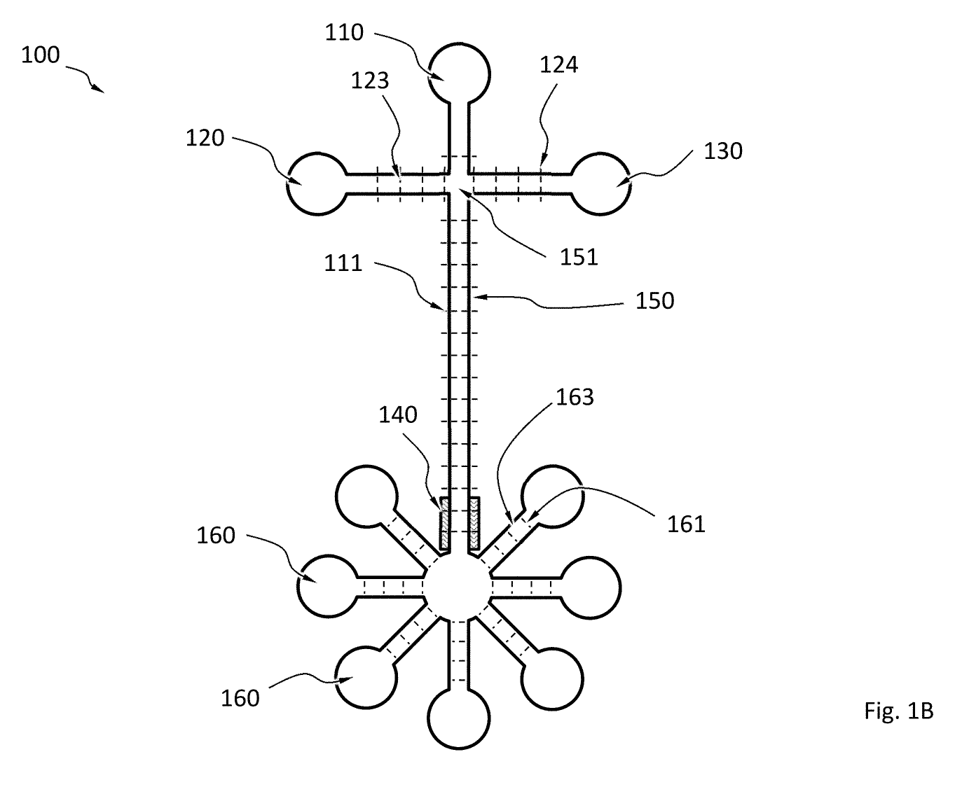

FIG. 1A schematically shows a top view of a device 100, according to an embodiment. The device 100 may have a buffer reservoir 110 configured to receive or store a buffer solution. The buffer reservoir 110 is fluidly coupled to an electrophoresis channel 150 such that the electrophoresis channel 150 is filled with the buffer solution. The device 100 has a sample reservoir 120 configured to receive or store a solution containing an analyte that will undergo electrophoresis. The sample reservoir 120 is fluidly coupled to the electrophoresis channel 150, for example, through a coupling channel 123. The device 100 may have a waste reservoir 130 fluidly coupled to the electrophoresis channel 150 through the coupling channel 123. An excess of the analyte from the sample reservoir 120 may be directed into the waste reservoir 130. The sample reservoir 120, the waste reservoir 130 if it is present, and the coupling channel 123 are configured such that the analyte may be directed into the electrophoresis channel 150 from the sample reservoir 120. In the example illustrated in FIG. 1A, the coupling channel 123 is in the same layer as and crosses the electrophoresis channel 150 at a crossing 151; as the analyte is directed from the sample reservoir 120 through the coupling channel 123, some of the analyte is in the electrophoresis channel 150 at the crossing 151 and can undergo electrophoresis. The coupling channel 123 is not necessarily in the same layer as the electrophoresis channel 150. Other arrangements of the coupling channel 123 are possible.

The device 100 may include at least three electrodes 124 configured to generate an electric field along the coupling channel 123. The electric field may be used to direct the analyte from the sample reservoir 120 along the coupling channel 123. The electrodes 124 may be exposed to the interior of the coupling channel 123 but not necessarily so. The electrodes 124 may be arranged to extend across the width of the coupling channel 123 as shown in FIG. 1A. Other ways of directing the analyte along the coupling channel 123 may be used. For example, the analyte may be drawn by a pump (e.g., a syringe pump coupled to the waste reservoir 130 or to the sample reservoir 120).

According to an embodiment, the device 100 includes at least three electrodes 111 configured to generate an electric field along the electrophoresis channel 150. The electrodes 111 may be configured to establish an electric field in a part of the electrophoresis channel 150 but not in another part, or to establish electric fields of different strengths in different parts of the electrophoresis channel 150, for example, by individually controlling the electrodes 111. The electric field in the electrophoresis channel 150 may be used to electrophorese the analyte in the electrophoresis channel 150, such as the analyte in the crossing 151, along the electrophoresis channel 150. The electrodes 111 may be exposed to the interior of the electrophoresis channel 150 but not necessarily so. The electrodes 111 may be arranged to extend across the width of the electrophoresis channel 150 as shown in FIG. 1A. Neighboring electrodes 111 may be spaced apart by a distance of 1 micrometer to 10 millimeters, or by a distance of 10 millimeters to 10 centimeters. The electrodes 111 do not have to be equally spaced.

According to an embodiment, the device 100 includes an optical detector 140 at a location of the electrophoresis channel 150. The optical detector 140 is integrated with the electrophoresis channel 150. The optical detector 140 does not have to have a particular spatial relationship with respect to the electrodes 111. For example, the optical detector 140 may be between two neighboring electrodes 111, underneath some of the electrodes 111 (i.e., some of the electrodes 111 are sandwiched between the optical detector 140 and the electrophoresis channel 150), or on a side of the electrophoresis channel 150 opposite to the electrodes 111. The optical detector 140 may be configured to detect fluorescence of the analyte as the analyte passes across the optical detector 140 during electrophoresis. The optical detector 140 may be configured to detect light scattering of the analyte as the analyte passes across the optical detector 140 during electrophoresis (e.g., a multi-angle light scattering (MALS) detector). The optical detector 140 may be configured to detect light transmission through the electrophoresis channel 150 as the analyte passes across the optical detector 140 during electrophoresis. The optical detector 140 may be an imaging detector, i.e., a detector capable of spatial resolution of optical signals. The optical detector 140 may be configured to detect a signal from the entirety or a part of the electrophoresis channel 150. The optical detector 140 may be a CMOS (complementary metal-oxide-semiconductor) optical detector. The signals the optical detector 140 detects may be used to determine whether, when or the nature of an electrophoresis band containing a component of the analyte as the band passes across the optical detector 140. The signals the optical detector 140 detects may be used to determine the quantity of the component of contained in the electrophoresis band.

According to an embodiment, the device 100 may have a number of collection channels 163 fluidly coupled to the electrophoresis channel 150 at the outlet thereof and a number of collection reservoirs 160 fluidly coupled to the collection channels 163. The collection channels 163 and the collection reservoirs 160 are configured to receive the components contained in various electrophoresis bands in the electrophoresis channel 150. The device 100 is configured to direct the electrophoresis bands into the collection reservoirs 160 through the collection channels 163. The signals the optical detector 140 detects may be used to control which collection channel 163 and which collection reservoir 160 the component contained in a particular electrophoresis band is directed into.

According to an embodiment, the device 100 may have a number electrodes 161 configured to generate an electric field along the collection channels 163. The electrodes 161 may be individually controllable. The electrodes 161 may be configured to establish an electric field in a part of the collection channel 163 but not in another part, to direct the component in an electrophoresis band into a collection reservoir 160 of choice. The electrodes 161 may be exposed to the interior of the collection channel 163 but not necessarily so. The electrodes 161 may be arranged to extend across the width of the collection channel 163 as shown in FIG. 1A. The device 100 may include electrodes 162 at branches of the collection channels 163. The electrodes 162 and the electrodes 161 may cooperatively direct a component contained in an electrophoresis band into one of the arms of a branch. An example of the electrodes 162 will be described in further details below. The collection channels 163 as shown in FIG. 1A have multiple branches but other arrangements are possible. For example, as shown in FIG. 1B, the collection channels 163 are arranged such that they are fluidly coupled the electrophoresis channel 150 without any branches.

The various channels of the device 100, such as the coupling channel 123, the electrophoresis channel 150 and the collection channel 163 may be formed by making an open trench in a substrate such as glass, polymer (e.g., polydimethylsiloxane, poly(methyl methacrylate), polyethylene, polystyrene, epoxy, polyurethane) and silicon, and then by closing the open trench with a cover plate (e.g., a semiconductor substrate, a glass substrate, a printed circuit board). The open trench may be made by a suitable technique such as lithography, molding or imprinting.

The various reservoirs of the device 100, such as the sample reservoir 120 and buffer reservoir 110, the waste reservoir 130, and the collection reservoirs 160 may be formed in the same substrate as the channels or in a different substrate (e.g., in the cover plate).

The various electrodes of the device 100, such as the electrodes 124, 111 and 161 may be a metal pattern formed on the substrate of the channels or on the cover plate. The electrodes may be isolated from the interior of the channels by covering them, for example, with a thin layer of a polymer or an inorganic insulating material (e.g., oxide and nitride). If the electrodes are exposed to the interior of the channels, the electrodes can be a material that is inert during the electrophoresis. An example of the material of the electrodes is platinum.

The optical detector 140 of the device 100 may be formed on the cover plate or a different substrate. The optical detector 140 and the electrodes 111 may be integrated in the same substrate.

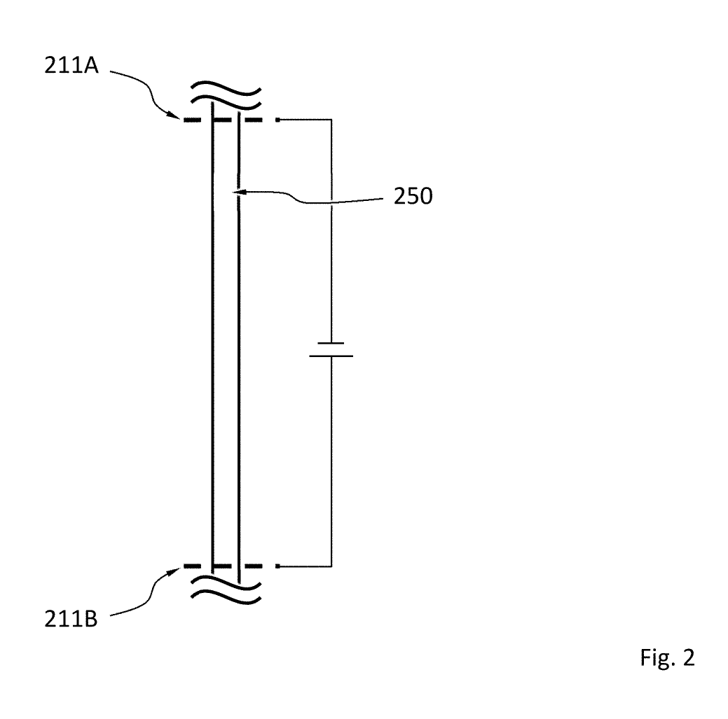

FIG. 2 schematically shows an electrophoresis channel 250 in a traditional electrophoresis apparatus, with two electrodes 211A and 211B at the upstream and downstream ends of the electrophoresis channel 250. The electrophoresis channel 250 has a length of centimeters and thus the electrodes 211A and 211B are spaced apart by centimeters. The electrodes 211A and 211B are used to establish an electric field over the length of the electrophoresis channel 250. In order to have this electric field sufficiently strong for electrophoresis, the voltage between the electrodes 211A and 211B is often hundreds of volts or more than a thousand volts.

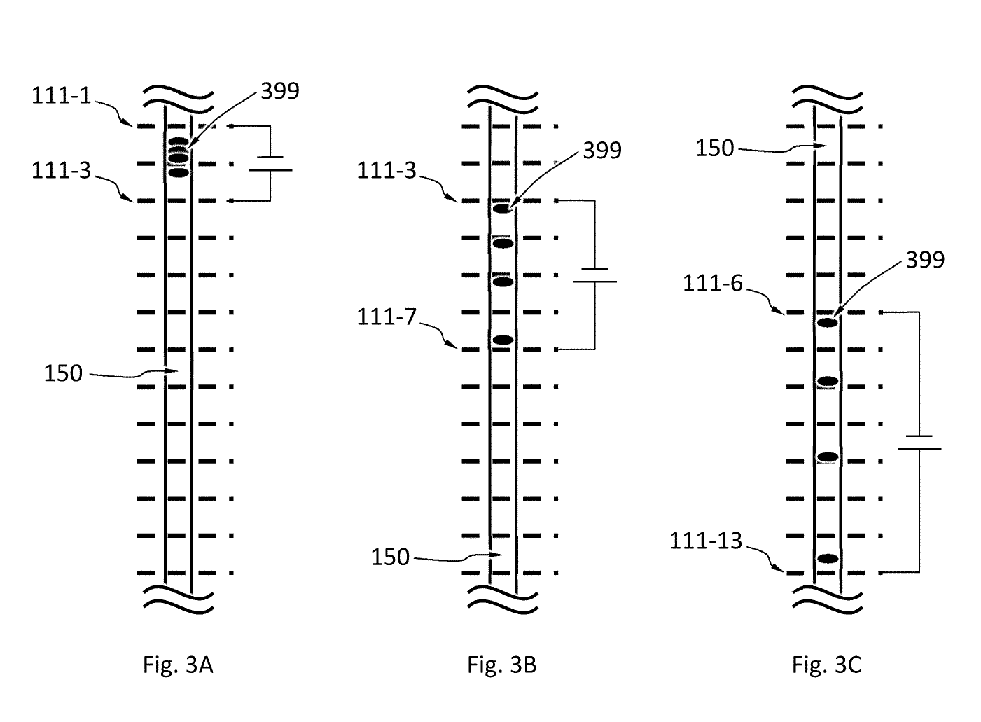

According to an embodiment, the plurality of electrodes 111 along the electrophoresis channel 150 in the device 100 may be used to electrophorese the analyte at a much lower voltage by establishing an electric field that moves downstream along the electrophoresis channel 150. FIG. 3A-FIG. 3C schematically show an example of the device 100 that has 13 electrodes 111 (labeled as 111-1, 111-2, 111-3, . . . , 111-13 as needed) arranged along the length of the electrophoresis channel 150. At the moment schematically shown in FIG. 3A, four bands 399 of the analyte are spatially close to one another between the electrodes 111-1 and 111-3, and thus only a local electric field between the electrodes 111-1 and 111-3 is needed to electrophorese the analyte. As the electrophoresis progresses, the bands 399 are more separated and have moved downstream along the electrophoresis channel 150. At the moment schematically shown in FIG. 3B, the bands 399 are between the electrodes 111-3 and 111-7, and thus only a local electric field between the electrodes 111-3 and 111-7 is needed to electrophorese the analyte. As the electrophoresis further progresses, the bands 399 are further separated and have moved downstream along the electrophoresis channel 150. At the moment schematically shown in FIG. 3C, the bands 399 are between the electrodes 111-6 and 111-13, and thus only a local electric field between the electrodes 111-6 and 111-13 is needed to electrophorese the analyte. As FIG. 3A-FIG. 3C schematically show, the electric field is local (i.e., not across the entire length of the electrophoresis channel 150) and the electric field is moving along the electrophoresis channel 150 over time. Compared to the traditional electrophoresis apparatus, the voltages needed in FIG. 3A-FIG. 3C are much lower.

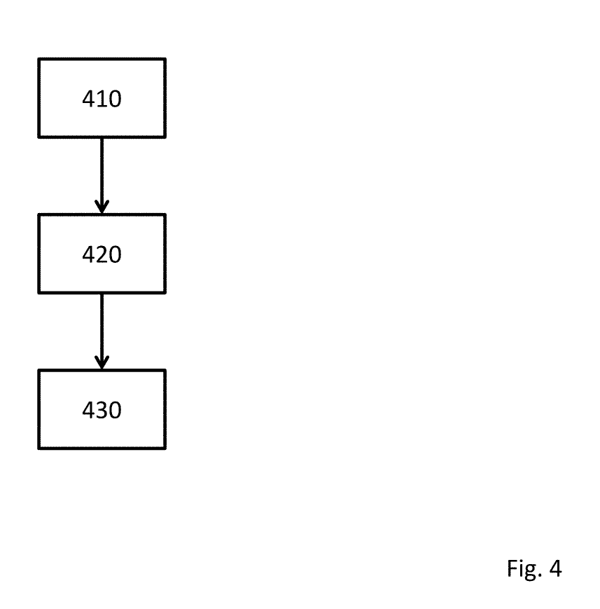

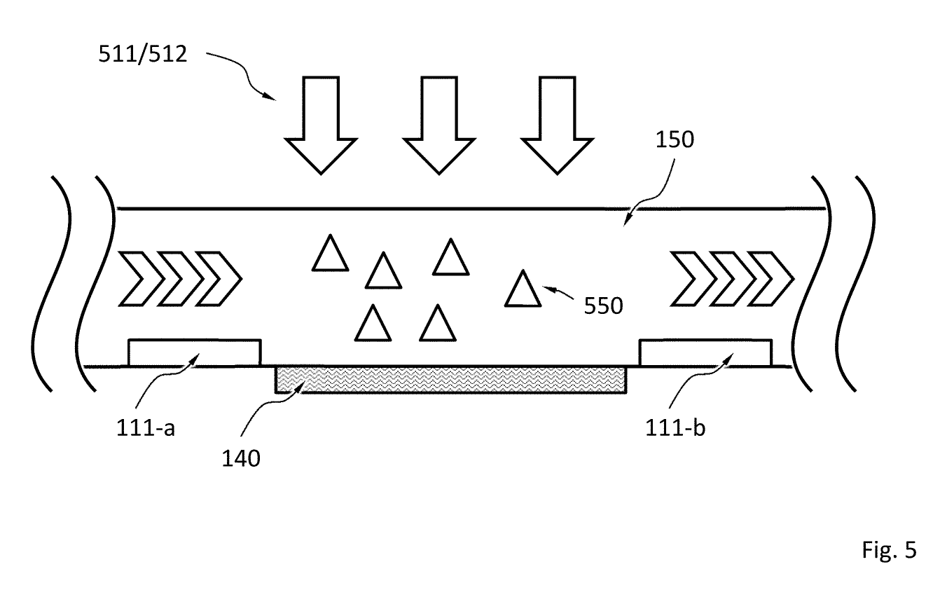

FIG. 4 schematically shows a flow chart for a method of electrophoresis. In procedure 410, an analyte (e.g., an analyte containing the components in the bands 399 in FIG. 3A) is introduced into a channel (e.g., the electrophoresis channel 150 in FIG. 3A). The channel may be filled with a buffer solution. The channel may have a cross-sectional area of less than 1 mm². The analyte may have a mixture of components. In procedure 420, the analyte is electrophoresed by establishing a first electric field between a first electrode (e.g., electrode 111-1 in FIG. 3A) upstream to the analyte (i.e., during electrophoresis the analyte moves away from the first electrode along the channel) and a second electrode (e.g., electrode 111-3 in FIG. 3A) downstream to the analyte (i.e., during electrophoresis the analyte moves toward the second electrode along the channel). In procedure 430, the analyte is electrophoresed by establishing a second electric field between a third electrode (e.g., electrode 111-6 in FIG. 3C) upstream to the analyte and a fourth electrode (e.g., electrode 111-13 in FIG. 3C) downstream to the analyte. The fourth electrode is downstream to the second electrode. The third electrode may be downstream to the first electrode. Alternatively, the third electrode and the first electrode may be the same electrode. The fluidic distance (i.e., distance along the channel) between the first and second electrodes may be smaller than the fluidic distance between the third and fourth electrodes. The strengths of the first electric field and the second electric field may be the same or different.

FIG. 5 schematically shows the function of the optical detector 140. In this example shown, the optical detector 140 is positioned between two (111-a and 111-b) of the electrodes 111. As a component 550 of the analyte passes across the optical detector 140 during electrophoresis in the electrophoresis channel 150, a signal caused by the component 550 is detected by the optical detector 140. The signal may be a peak (i.e., a temporal increase and decrease of the intensity) of fluorescence if the component 550 fluoresces under an external excitation light 511. The signal may be a dip (i.e., a temporal decrease and increase of the intensity) of transmission of an external light 512 through the electrophoresis channel 150. The signal may be a peak (i.e., a temporal increase and decrease of the intensity) of scattered light by the component 550.

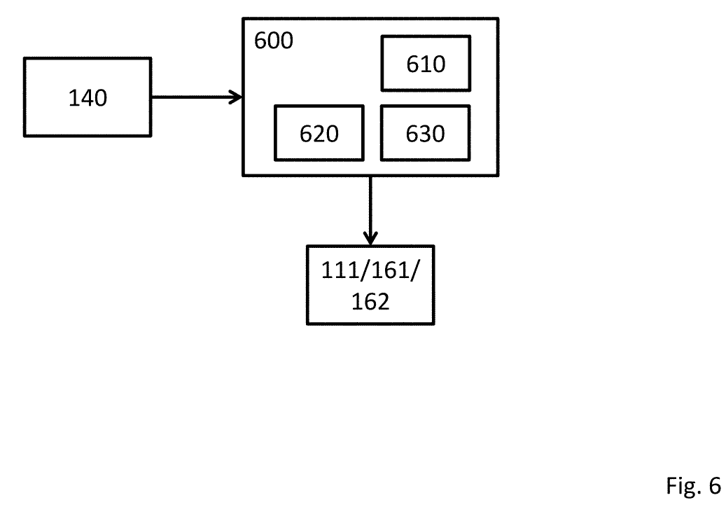

The device 100 may have a controller 600, as FIG. 6 schematically shows. The controller 600 may have a processor 610, a memory 620 and a power supply 630. The controller 600 receives an output from the optical detector 140. The output represents the signal the optical detector 140 detects from the electrophoresis channel 150. The processor 610 executes instructions stored in the memory 620 and may determine the quantity or identity of the component contained in an electrophoresis band in the electrophoresis channel 150. The processor 610 executes instructions stored in the memory 620 and may determine the location of the electrophoresis band in the electrophoresis channel 150. The identity or the location may be used to determine when and which electrodes 111 or 161 to energize using the power supply 630 to collect the component into a collection channel and collection reservoir of choice. For example, the location of the electrophoresis band may be used to determine when the band will reach the end of the electrophoresis channel 150, and energize the appropriate electrodes 161 at time the band reaches the end of the electrophoresis channel 150 to direct the band into one of the collection channels 163.

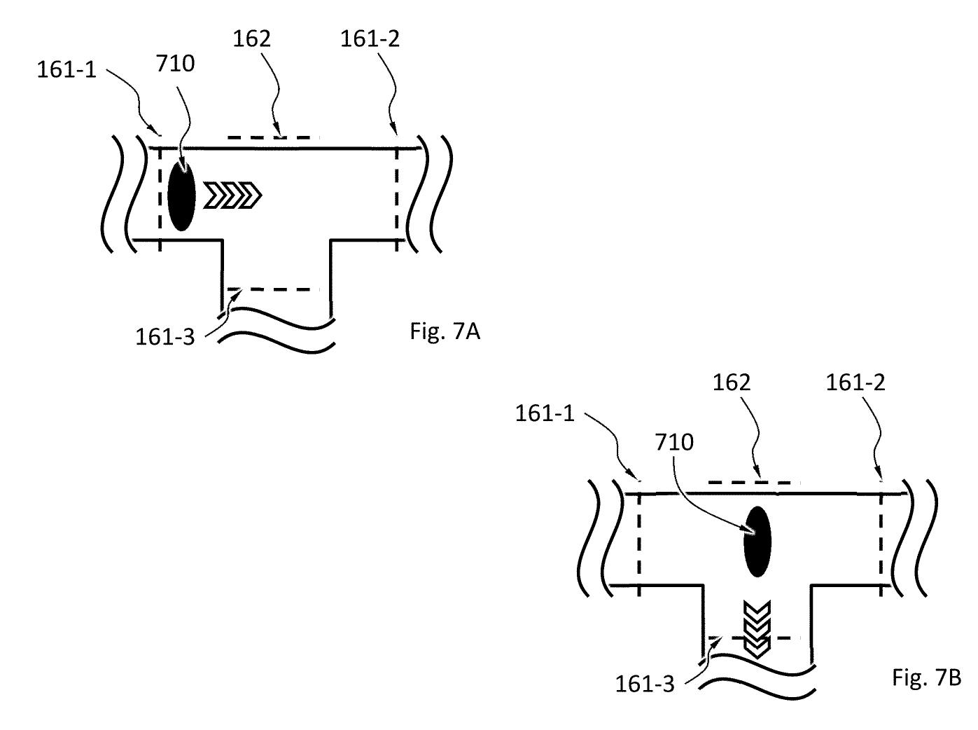

FIG. 7A and FIG. 7B schematically show one way to use the electrodes 161 to direct an electrophoresis band 710 selectively to one of the arms of a branch. At the moment shown in FIG. 7A, before the band 710 drift into the branch, an electric field may be established between the electrodes 161-1 and 161-2 to draw the band 710 into the branch. There may be an electric field between the electrode 162 and the electrode 161-3 to turn the motion of the band 710 toward one of the arms. As shown in FIG. 7B, when the band 710 reaches a location between the electrode 162 and the electrode 161-3, an electric field is established between the electrode 162 and the electrode 161-3 to direct the band 710 into one of the arms of the branch.

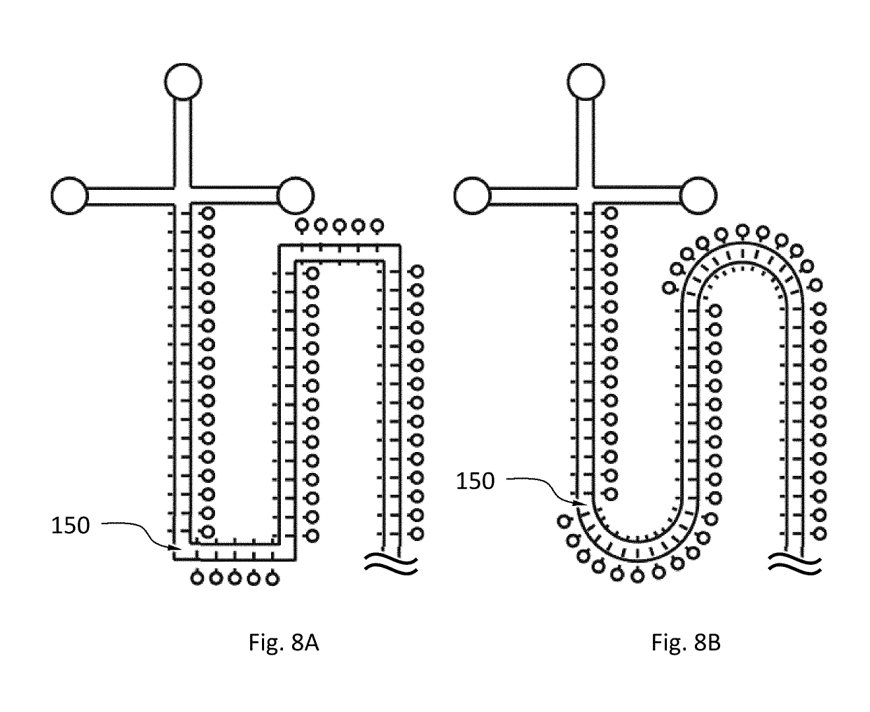

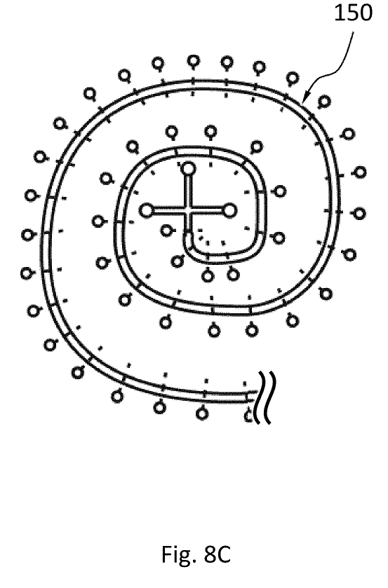

The electrophoresis channel 150 does not have to be straight. The electrophoresis channel 150 may be arranged in any suitable shape such as those shown in FIG. 8A-FIG. 8C.

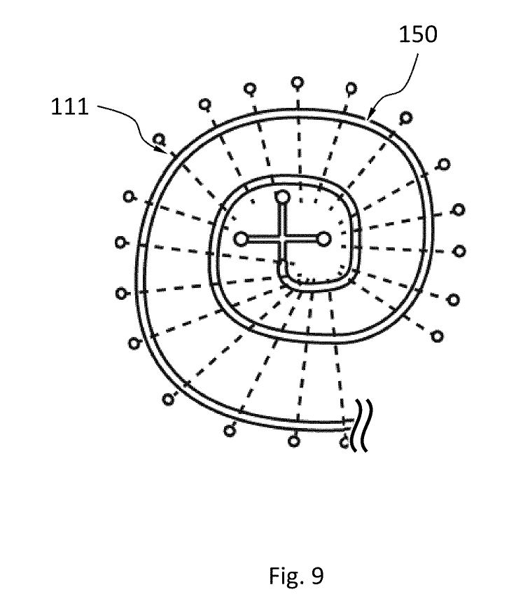

FIG. 9 schematically shows that some of the electrodes 111 may not be controlled independently from one another. For example, a plurality of electrodes 111 at different locations of the electrophoresis channel 150 may be electrically connected. This arrangement may simplify the wiring to the electrodes 111.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A device, comprising:
an electrophoresis channel;
a first plurality of at least three electrodes configured to establish an electric field in a part of the electrophoresis channel but not in another part, or to establish electric fields of different strengths in different parts of the electrophoresis channel;
an optical detector integrated with the electrophoresis channel, configured to detect a signal of an analyte as the analyte passes across the optical detector during electrophoresis.

2. The device of claim 1, further comprising a buffer reservoir configured to receive or store a buffer solution and fluidly coupled to the electrophoresis channel.

3. The device of claim 1, further comprising a sample reservoir configured to receive or store a solution containing the analyte and fluidly coupled to the electrophoresis channel.

4. The device of claim 3, further comprising a coupling channel, wherein the sample reservoir is fluidly coupled to the electrophoresis channel through the coupling channel.

5. The device of claim 4, further comprising a waste reservoir fluidly coupled to the electrophoresis channel through the coupling channel.

6. The device of claim 4, wherein the sample reservoir and the coupling channel are configured to direct the analyte into the electrophoresis channel.

7. The device of claim 6, wherein the coupling channel crosses the electrophoresis channel at a crossing and wherein the sample reservoir and the coupling channel are configured to direct the analyte into the crossing.

8. The device of claim 4, further comprising a second plurality of at least three electrodes configured to direct the analyte from the sample reservoir along the coupling channel.

9. The device of claim 1, wherein the first plurality of electrodes are individually controllable.

10. The device of claim 1, wherein the first plurality of electrodes are exposed to an interior of the electrophoresis channel.

11. The device of claim 1, wherein the optical detector is between two neighboring ones of the first plurality of electrodes, or wherein the optical detector is underneath some of the first plurality of electrodes, or wherein the optical detector is on a side of the electrophoresis channel opposite to the first plurality of electrodes.

12. The device of claim 1, wherein the signal is fluorescence, transmission of light, or scattering of light.

13. The device of claim 1, wherein the optical detector is configured to detect a signal from a part of the electrophoresis channel.

14. The device of claim 1, wherein the optical detector is a CMOS optical detector.

15. The device of claim 1, further comprising a plurality of collection channels fluidly coupled to an outlet of the electrophoresis channel and further comprising a plurality of collection reservoirs fluidly coupled to the collection channels, wherein the collection channels and the collection reservoirs are configured to receive components of the analyte contained in electrophoresis bands in the electrophoresis channel.

16. The device of claim 15, further comprising a third plurality of electrodes configured to direct the components into the collection reservoirs.

17. The device of claim 1, wherein the electrophoresis channel comprises a trench in a substrate and a cover plate closing the trench.

18. The device of claim 17, wherein the substrate comprises glass, a polymer, or silicon.

19. The device of claim 17, wherein the cover plate comprises a semiconductor, glass, or a printed circuit board.

20. The device of claim 17, wherein the optical detector is in the cover plate.

21. The device of claim 17, wherein the first plurality of electrodes are on the cover plate.

22. The device of claim 1, further comprising a controller comprising a processor, a memory and a power supply, wherein the controller is configured to receive an output from the optical detector, the output representing the signal the optical detector detects from the electrophoresis channel.

23. The device of claim 22, wherein the processor is configured to execute instructions stored in the memory and to determine a quantity or identity of a component contained in an electrophoresis band in the electrophoresis channel.

24. The device of claim 22, wherein the processor is configured to execute instructions stored in the memory and to determine a location of an electrophoresis band in the electrophoresis channel.

25. The device of claim 22, wherein the processor is configured to determine when and which of the first and third plurality of electrodes to energize using the power supply, based on an identity or location of an electrophoresis band in the electrophoresis channel.

26. (canceled)

27. (canceled)

28. (canceled)

29. (canceled)
